(19) United States
(12) Patent Application Publication
(10) Pub. No.: US 2009/0304043 A1
(43) Pub. Date: Dec. 10, 2009

(54) Temperature Sensor

(75) Inventors: Manfred Glehr, Wenzenbach (DE); Stephan Heinrich, Pfeffenhausen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/309,562

(22) PCT Filed: Jul. 17, 2007
(86) PCT No.: PCT/EP2007/057370

§ 371 Date: Jan. 22, 2009

(30) Foreign Application Priority Data
Jul. 24, 2006 (DE) 10 2006 034 181.3

(51) Int. Cl. G01K 7/22; G01K 1/00

(52) U.S. Cl. 374/183; 374/208; 374/E07.028; 374/E01.001

(57) ABSTRACT

The invention relates to a temperature sensor comprising a sense element and being in contact with a housing configured as a contact wire of the temperature sensor. A contact wire arranged inside the housing, is configured concentrically and is held under spring tension with an angular spring. For testing purposes, a testing resistor, being connected parallel to the sensor element is proposed.

The invention relates to a temperature sensor for determining the temperature of exhaust gases from an internal combustion engine, having a temperature-sensitive sensor element which is arranged in a housing, and having a contact line which runs in the interior of the housing and is connected to the sensor element.

A temperature sensor of this kind is known from DE 101 58 529 A1. The known temperature sensor has a cylindrical housing which can be inserted into the wall of an exhaust gas line. Through-holes through which exhaust gas can enter the housing are provided at that end of the housing which can be inserted into the exhaust gas line. A ceramic substrate on which a thermistor is formed in the region of the through-holes extends within the housing. Furthermore, contact lines are formed on the ceramic substrate, said contact lines being routed through a retaining element which is arranged in the interior of the housing. Contact clips to which external cables can be fitted are arranged at that end of the ceramic substrate which is provided for connecting cables. Since the retaining element which is provided for retaining the ceramic substrate in the housing is wound from a metal mesh, the interior of housing is not sealed off by the retaining element. Therefore, a seal with which the housing can be sealed off at the cable end is provided in the region of the cables which are connected to the contact clips.

The known temperature sensor serves to monitor the exhaust gas temperature of internal combustion engines. The exhaust gas temperature of internal combustion engines is an important parameter for engine control. In particular, the engine assemblies should be protected against overheating and the pollutants expelled by the internal combustion engine should be minimized. In the case of diesel engines, the soot particle filter is monitored in particular. The temperatures occurring in the exhaust gas are up to 1100° in this case.

The known temperature sensor is mounted by the seal being fitted to the cables. The cables are then connected to the contact clips and the retaining element is wound around the ceramic substrate. The ceramic substrate is then inserted into the housing, and the seal which surrounds the external cable is inserted into the cable-end opening in the housing.

One disadvantage of the known temperature sensor is that soot particles enter the interior of the temperature sensor through the through-holes in the housing and can accumulate there. As a result, the measurement behavior of the temperature sensor can change over time. In addition, mounting of the known temperature sensor is complex since the retaining element which is wound from a mesh does not retain the ceramic substrate in a defined position. In addition, the retaining element can slide along the ceramic substrate when the retaining element is inserted into the housing together with the ceramic substrate.

Taking this prior art as a starting point, the invention is therefore based on the object of providing a temperature sensor which can be mounted in a simple manner and has defined measurement properties.

This object is achieved by a temperature sensor having the features of the independent claim. Advantageous refinements and developments are specified in claims which are dependent on said independent claim.

In the temperature sensor, the temperature-sensitive sensor element is in contact with the housing which is in the form of a contact line. As a result, mounting of the sensor element in the housing is considerably simplified since the sensor element can be placed in the housing in a simple manner. The situation of the housing being in the form of a contact line also contributes to simplifying mounting since a contact line has to be routed less to the sensor element in the interior of the housing. Furthermore, no openings are required in the wall of the housing since the sensor element is thermally coupled to the external gas stream via the wall of the housing. Therefore, no soot particles can accumulate in the interior of the housing either. On account of the sensor element resting against the housing, the sensor element finally has a defined position in relation to the housing, so that the thermal coupling between the sensor element and the housing is in each case the same in the case of different examples of the temperature sensor. The variation in the measurement properties of the temperature sensor turns out to be accordingly low. The temperature sensor can therefore be mounted in a simple manner and has a defined temperature behavior.

In a preferred embodiment, the contact line which is connected to the sensor element runs concentrically in the interior of the housing. In this case, it does not depend on the angular position of the contact line, so that contact is established between the contact line which runs in the interior of the housing and the sensor element. Mounting is further simplified as a result.

The inner contact line is preferably embedded in an insulation means with a concentric passage. This measure ensures that the inner contact line is in a defined position with respect to the housing and is in contact with the sensor element.

The sensor element may be, for example, a thermistor. Only two contact lines are required to connect thermistors, and so the housing which is in the form of a contact line and the inner contact line are sufficient.

The thermistor is preferably a thermistor with a negative temperature coefficient, a so-called negative temperature coefficient thermistor. Sensor elements of this type are cost-effective to manufacture and are suitable for measuring high temperatures, as occur in exhaust gas.

In order to permit fault diagnosis in the temperature sensor, a test resistor is connected in parallel with the negative temperature coefficient resistor. The test resistor can be used to determine whether there is a short circuit on the path to the test resistor or an interruption in the cable and the contact lines in the interior of the temperature sensor.

The test resistor is preferably designed to complement the inner contour of the housing and rests on the inner face of the housing by way of its outer face. Since such a configuration and arrangement of the test resistor do not depend on the angular position of the test resistor, the test resistor can be mounted in the interior of the housing in a simple manner.

Contact between the sensor element and the inner contact line is preferably established with the aid of a spring element which exerts a spring force on the inner contact line and the sensor element. This spring element may be, for example, an annular spring which imparts the contact between the inner contact line and the test resistor which rests on the inner face of the housing.

A spring element of this kind rests, for example by way of the side which faces the sensor element, on the test resistor and the inner contact line. On that side of which is averted from the sensor element, the spring element can rest against a supporting device which is formed by the housing of the temperature sensor or by a further insert.

Furthermore, a circuit mount on which a sensor circuit for operating the sensor element is formed can be provided in the interior of the housing. This provides the advantage that the temperature sensor can be equipped with additional intelligence for monitoring the sensor element. In addition, digital data transmission to a central on-board computer can be set up. The influence of interference can be reduced by digital data transmission. The fact that the sensor circuit is shielded in the interior of the housing also contributes to security against interference.

Further advantages and properties of the invention can be gathered from the following description, in which exemplary embodiments of the invention are explained in detail with reference to the attached drawing, in which:

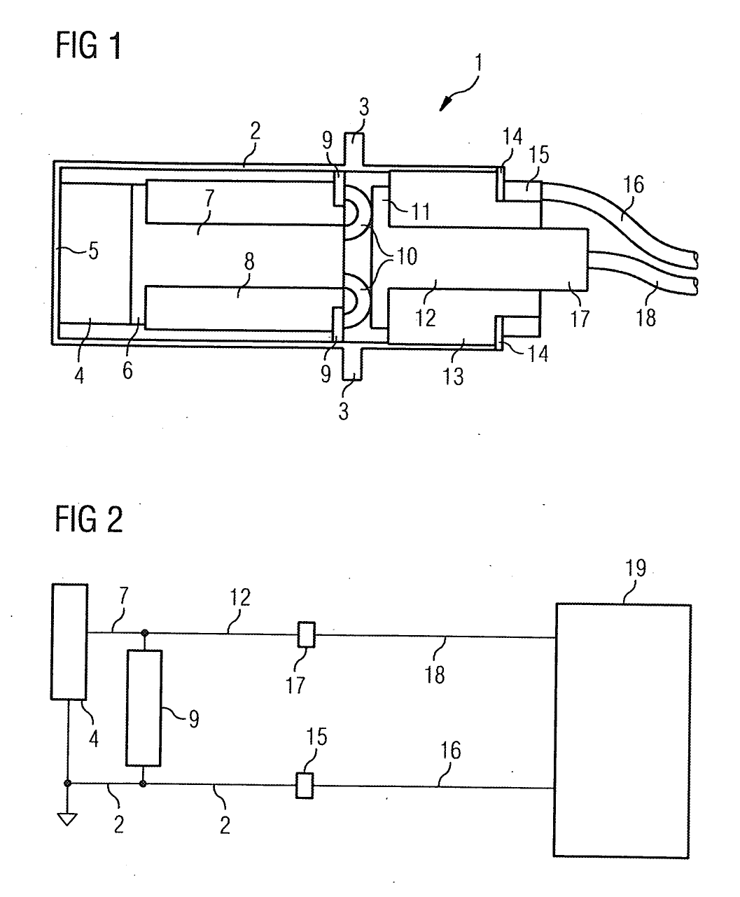

FIG. 1 shows a longitudinal section through a temperature sensor;

FIG. 2 shows an equivalent circuit diagram for the temperature sensor from FIG. 1;

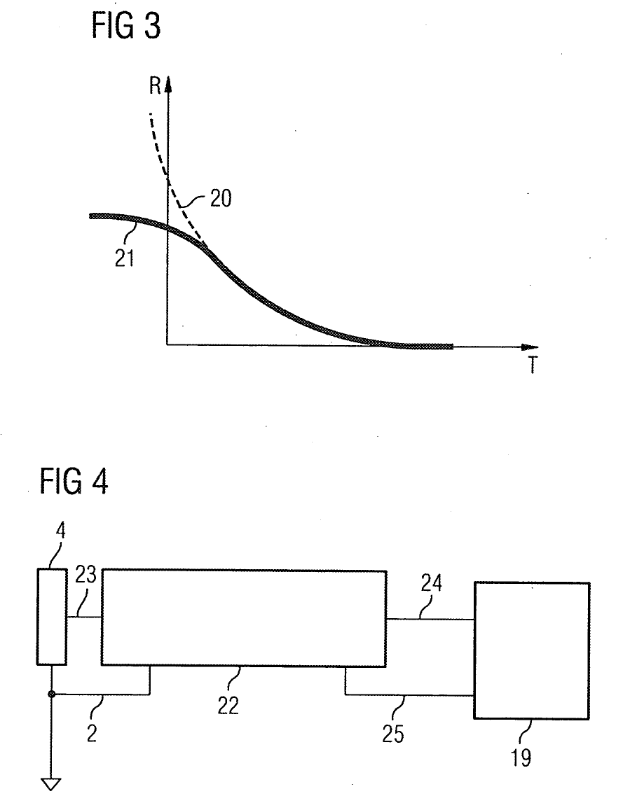

FIG. 3 shows a graph in which the characteristic curve of the temperature sensor from FIG. 1 is plotted; and

FIG. 4 shows a block diagram of a further temperature sensor.

FIG. 1 shows a temperature sensor 1 which is provided for measuring the temperature of exhaust gases. The temperature sensor 1 has an elongate cylindrical housing 2 on which a circumferential stop ring 3 is formed. The stop ring 3 defines a stop up to which the housing 2 of the temperature sensor 1 can be inserted into the wall of an exhaust gas line. To this end, a nozzle can be formed on the exhaust gas line, the temperature sensor 1 being inserted into said nozzle and it being possible for the temperature sensor 1 to be fixed to said nozzle, for example with the aid of a union nut.

A thermistor 4 which rests against a base 5 of the housing 2 is arranged in the interior of the housing 2. The thermistor 4 is, in particular, a negative temperature coefficient thermistor which is designed to measure high temperatures in the region of up to 1100° C. However, the thermistor 4 may also be a platinum resistor. On that side which is opposite the base 5, the thermistor 4 is covered by a contact disk 6 which is connected to a contact pin 7. The contact pin 7 is surrounded by an insulating sleeve 8. The insulating sleeve 8, which rests against the inner face of the housing 2, retains the contact pin 7 and therefore the contact disk 6 in an approximately concentric position. When the thermistor 4 is fitted to the contact disk 6, the insulating sleeve 8 also keeps the thermistor 4 at a distance from the housing 2.

Since the temperature sensor 1 is inserted into an exhaust gas line as far as the stop ring 3, the thermistor 4 and also the contact disk 6, the contact pin 7 and the insulating sleeve 8 are located in a section of the housing 2 which is at an elevated temperature. The insulating sleeve 8 is therefore preferably produced from a ceramic material.

An annular test resistor 9 which is electrically conductively connected to the contact pin 7 via an annular spring 10 is arranged at the opposite end of the insulating sleeve 8. The annular spring 10 is retained by a contact disk 11. The contact disk 11 is connected to a further contact pin 12. The contact pin 12 and the contact disk 11 are retained by an insulating sleeve 13 which is pressed against the contact disk 11 and therefore onto the annular spring 10 by a housing cover 14, for example. The insulating sleeve 13 can likewise be produced from a ceramic material. However, since the insulating sleeve 13 is located outside the exhaust gas line and therefore is not exposed to the high exhaust gas temperatures, other insulating materials, for example plastics, can also be used. The housing cover 14 can also be replaced by lugs of the housing which are bent inward toward the insulating sleeve 13 after the elements which are located in the interior of the housing 2 are mounted. Furthermore, a helical spring can also be used in place of the annular spring 10.

A fixing apparatus 15 for connecting a ground cable 16 and a further fixing apparatus 17 for connecting a signal cable 18 can also be provided in the region of the housing cover 14.

In order to make mounting of the temperature sensor 1 as simple as possible, the components which are arranged in the interior of the housing 2, in particular the thermistor 4, the contact disks 6 and 11, the contact pins 7 and 12 and the annular spring 10, are preferably of rotationally symmetrical design. Furthermore, a recess which complements the test resistor 9 is preferably provided on the insulating sleeve 8.

In order to mount the temperature sensor 1, the thermistor 4, together with the contact disk 6 and the contact pin 7 fitted to it, are inserted into the housing 2. The insulating sleeve 8 is then pushed in. The test resistor 9 and the annular spring 10 can then be inserted. The housing cover 14 can be fitted after the contact disk 11, the contact pin 12 and the insulating sleeve 13 are inserted. Finally, the ground cable 16 and the signal cable 18 are in each case fitted to the fixing apparatuses 15 and 17.

Since the components which are inserted into the interior of the housing 2 are of concentric design, mounting of the temperature sensor 1 can be carried out in a simple manner and sometimes by machine.

Since the thermistor 4 rests directly on the base 5 of the housing 2, effective thermal coupling is established between the thermistor 4 and the exhaust gas which flows around the housing 2. Short response times for the temperature sensor 1 are correspondingly produced. Furthermore, no passages are required in the housing 2 in order to thermally couple the thermistor 4 to the exhaust gas. Soot particles contained in the exhaust gas can therefore settle on the surface of the housing 2 only if they are not removed from the exhaust gas stream again. It is therefore not possible for soot particles to accumulate in the interior of the housing 2.

A further advantage of the temperature sensor 1 is that the components are located in the interior of the housing 2 under spring stress. As a result, the components which are located in the interior of the housing 2 can be produced in a fault-tolerant fashion. In addition, no costly welding points are required.

The functioning of the feed lines as far as the test resistor 9 can be checked by the test resistor 9 which is integrated in the temperature sensor 1. FIG. 2 shows an equivalent circuit diagram of the temperature sensor 1, in which the connection of the thermistor 4 to a controller 19 is clear. The controller 19 may be, for example, an on-board computer. FIG. 2 shows that the functioning of the feed lines, specifically of the signal cable 18 and of the contact pin 12, and the functioning of the ground line, specifically of the housing 2 and of the ground cable 16, can be examined for short circuits by means of the test resistor 9.

However, the presence of the test resistor 9 changes the characteristic curve of the thermistor 4.

FIG. 3 shows a graph in which the characteristic curve of the temperature sensor 1 is plotted. A resistance curve 20 expresses the dependence of the resistance of the thermistor 4 as a function of the temperature. The resistance curve 20 rises sharply as temperatures fall. A further resistance curve 21 shows the dependence of the resistance of the temperature sensor 1 on the temperature. The resistance curve 21 initially rises as the temperature decreases and then flattens out in accordance with the resistance value of the test resistor 9. The value of the test resistor 9 is typically in the range of between 10 and 20 kΩ.

In a modification to the temperature sensor 1 which is described with reference to FIGS. 1 to 3, a circuit mount 22 which is connected to the thermistor 4 via a contact line 23 can be arranged in the interior of the housing 2. The contact line 23 can be designed to correspond to the contact disk 6 and the contact pin 7. Sensor circuits which serve, for example, to process signals, in particular to amplify signals, can be formed on the circuit mount 22. In particular, a digital measurement signal can be generated which is transmitted to the controller 19 via a data line 24. As a result, the security against interference in particular can be improved when the measurement signal is transmitted. A protocol, for example SAE SENT, can be used for data transmission. However, data transmission may also be performed with the aid of pulse-width modulation. Furthermore, the sensor circuit switches formed on the circuit mount 22 can also provide an open collector output. Power can also be supplied to the sensor circuit via the data line 24 by a DC component being superimposed on the data signal for example. Furthermore, it is also possible to arrange additional sensors on the circuit mount 22, said sensors being used to monitor, for example, the temperature in the region of the circuit mount 22. Any possible overheating of the circuit mount 22 can be identified in this way. Finally, the thermistor 4 can also be fixed to or arranged on the circuit mount 22.

Finally, it should also be noted that the controller 19 is connected to the circuit mount 22 both via the data line 24 and via a ground line 25.

It should be noted that, in the claims and in the description, the singular covers the plural, even if the context results in something different. Both the singular and the plural are meant particularly when the indefinite article is used.

It should finally be noted that features and properties which have been described in connection with a specific exemplary embodiment can also be combined with another exemplary embodiment, except when this is precluded for reasons of compatibility.

1.-15. (canceled)

16. A temperature sensor for determining the temperature of exhaust gases from an internal combustion engine, the temperature sensor comprising:
a housing;
a temperature-sensitive sensor element arranged in an interior of the housing;
at least one contact line in the interior of the housing coupled to the sensor element; and
a spring element arranged in the interior of the housing configured to exert a spring force that acts in an axial direction on the sensor element and the at least one contact line
wherein the sensor element contacts the housing which is a further contact line.

17. The temperature sensor according to claim 16, wherein the at least one contact line is of concentric design.

18. The temperature sensor according to claim 17, wherein at least a portion of the at least one contact line is held by a concentric insulation means.

19. The temperature sensor according to one of claim 16, wherein the sensor element is a thermistor.

20. The temperature sensor according to claim 19, wherein the thermistor is a negative temperature coefficient thermistor.

21. The temperature sensor according to claim 20, further comprising a test resistor connected in parallel with the sensor element in the interior of the housing.

22. The temperature sensor according to claim 21, wherein the test resistor is of annular design having an outer face and configured to contact an inner face of the housing by the outer face.

23. The temperature sensor according to claim 22, wherein the spring is an annular spring is configured to establish electrical contact between the test resistor and the at least one contact line.

24. The temperature sensor according to one of claim 16, further comprising a circuit mount, the circuit mount comprising a sensor circuit configured to operate the sensor element.

25. The temperature sensor according to claim 24, wherein the sensor circuit is configured to generate a digital data signal.

26. The temperature sensor according to claim 24, wherein the sensor circuit is configured to detect at least one additional physical variable.

27. The temperature sensor according to claim 26, wherein a temperature in a region of the sensor circuit is detected using the sensor circuit.

28. The temperature sensor according to claim 24, wherein the sensor element is arranged on the circuit mount.

29. The temperature sensor according to claim 24, wherein the circuit mount is arranged in the interior of the housing.

30. The temperature sensor according to claim 21, further comprising at least one contact pin in electrical connection with the thermistor.

31. The temperature sensor according to one of claim 19, wherein the thermistor is a platinum resistor.

32. The temperature sensor according to claim 21, wherein a resistance of the test resistor is less than about 20 kΩ.

33. The temperature sensor according to claim 21, wherein a resistance of the test resistor is greater than about 10 kΩ.

34. A temperature sensor according to claim 16, wherein the at least one contact line comprises a contact disk and a contact pin, and
wherein the thermistor, the contact disk, the contact pin, and the annular spring are configured to be rotationally symmetrical.

35. A temperature sensor according to claim 34, further comprising an insulating sleeve surrounding the contact pin.
